(19) United States
(12) Patent Application Publication
(10) Pub. No.: US 2003/0181087 A1
(43) Pub. Date: Sep. 25, 2003

(54) Electrical connector

(75) Inventor: Sergio Corona, Upland, CA (US)

Correspondence Address: WILLIAM COLLARD, COLLARD & ROE, P.C., 1077 NORTHERN BOULEVARD, ROSLYN, NY, 11576, US

(73) Assignee: DSM & T CO., Inc.

(21) Appl. No.: 10/104,188

(22) Filed: Mar. 22, 2002

(51) Int. Cl. H01R 13/52

(52) U.S. Cl. 439/278

(57) ABSTRACT

An electrical connector comprises a housing made of a flexible material and an electrical receptacle encompassed by the body. There is an extension surrounding and protruding beyond the front face to protect the front face. There is a wiper disposed on the extension adjacent each side of the housing. The wiper has a generally triangular shape. The wiper prevents water and moisture from migrating into the electric box when performing a pressure test. There is a locking seal disposed around an interior face of the extension to lock the housing to an electrical receptacle.

### BACKGROUND OF THE INVENTION

1. Field of the Invention

This invention relates to an improved electrical connector with moisture sealing properties.

2. The Prior Art

When using electrical wires outdoors, it is important that the plug and receptacles into which the plugs are placed be sealed from moisture. There have been many attempts to provide suitable housings for such plugs and receptacles, but many of them fail to provide an adequate watertight seal, thus leading to corrosion of the parts and failed electrical connections.

### SUMMARY OF THE INVENTION

It is therefore an object of the invention to provide an electrical connector that has improved water resistance.

This and other objects are accomplished with an electrical connector comprising a housing made of a flexible material and an electrical receptacle encompassed by the body. There is an extension surrounding and protruding beyond the front face to protect the front face. There is a wiper disposed on the extension adjacent each side of the housing. The wiper has a generally triangular shape. The wiper prevents water and moisture from migrating into the electric box when performing a pressure test. There is a locking seal disposed around an interior face of the extension to lock the housing to an electrical plug.

There are a plurality of mounting bars disposed on the top and bottom of the housing. The mounting bars are softer and provide a higher locking seal around the mounting surface.

The extension has a reinforced ridge surrounding an exterior face for preventing warping and bending of the extension during use.

There is an opening on the back of the housing for allowing wires to enter and connect with the plug. The opening is large enough to allow cables to fit through.

There is an o-ring surrounding the housing adjacent the extension for applying constant pressure and preventing moisture and water from entering the housing. The o-ring provides an additional seal and stabilizes the mounting surface of the housing to a mounting box.

The flexible material is preferably an elastomer but any suitable waterproof, flexible material could be used.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of the housing according to the invention;

FIG. 2 shows a top view of the housing;

FIG. 3 shows a front view of the housing;

FIG. 4 shows a side view of the housing, and

FIG. 5 shows a rear view of the housing.

### DETAILED DESCRIPTION OF THE PREFERRED EMBODIMENT

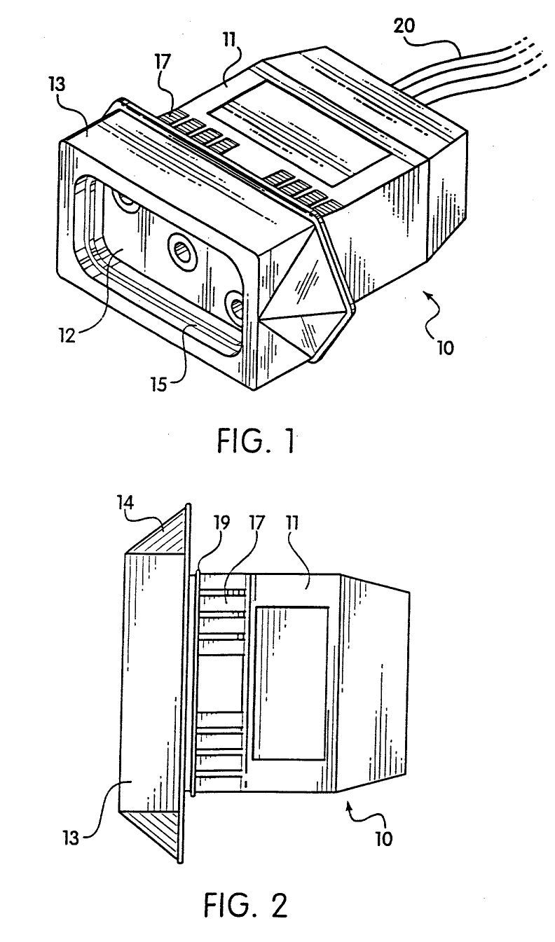

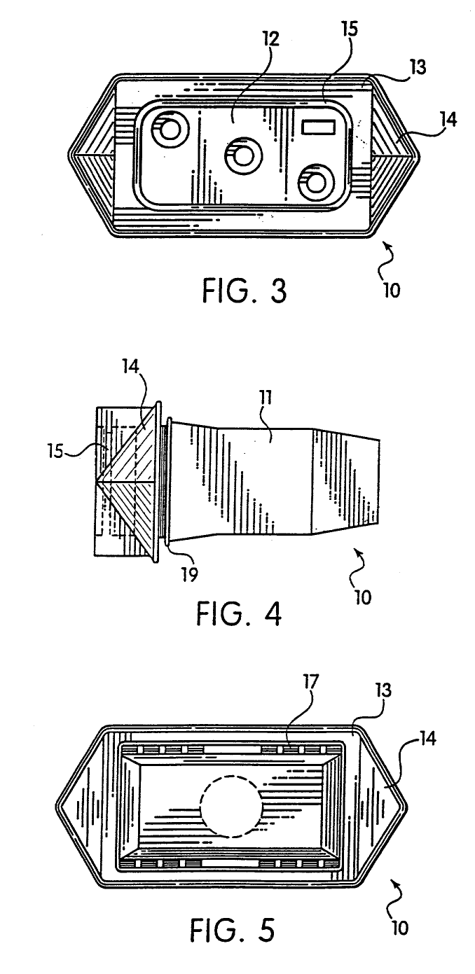

Referring now in detail to the drawings and, in particular, FIGS. 1-3 show the connector 10 according to the invention. Connector 10 comprises a housing 11 made of a flexible material and an electrical receptacle 12 encompassed by said housing. There is an extension 13 surrounding and protruding beyond the front face of the housing 11 to protect it from moisture. Extension 13 has a wiper 14 adjacent each side housing 11. Wiper 14 has a generally triangular shape and prevents water and moisture from migrating into the electric box when performing a pressure test. There is a locking seal disposed around an interior face of extension 13 to lock the housing 11 to an electrical receptacle.

There are a plurality of mounting bars 17 disposed on the top and bottom faces of housing 11.

Extension 13 has a reinforced ridge 18 surrounding an exterior face for preventing warping and bending of extension 13.

Housing 11 has an opening 19 on a back end for allowing wires 20 to enter and connect with receptacle 12.

There is an o-ring 21 surrounding housing 11 adjacent extension 13 for applying constant pressure and preventing moisture and water from entering housing 11.

Accordingly, while only a single embodiment of the present invention has been shown and described, it is obvious that many changes and modifications may be made thereunto without departing from the spirit and scope of the invention.

What is claimed is:

1. An electrical connector comprising:
a housing made of a flexible material and having a top, a bottom, two sides, a front face and a back;
an electrical receptacle encompassed by said body;
an extension surrounding and protruding beyond said front face to protect said front face;
a wiper disposed on said extension adjacent each side of said housing; and
a locking seal disposed around an interior face of said extension to lock said housing to an electrical plug.

2. The electrical connector according to claim 1, further comprising a plurality of mounting bars disposed on said top and bottom of said housing.

3. The electrical connector according to claim 1, wherein said extension has a reinforced ridge surrounding an exterior face of said extension for preventing warping and bending of said extension.

4. The electrical connector according to claim 1, further comprising an opening on said back of said housing for allowing wires to enter and connect with said receptacle.

5. The electrical connector according to claim 1, further comprising an o-ring surrounding said housing adjacent said extension for applying constant pressure and preventing moisture and water from entering said housing.

6. The electrical connector according to claim 1, wherein the flexible material is an elastomer.

7. The electrical connector according to claim 1, wherein the wiper has a generally triangular shape.
